(19) United States
(12) Patent Application Publication
(10) Pub. No.: US 2026/0304313 A1
(43) Pub. Date: Oct. 1, 2026

(54) ENERGY RELATED SUBSCRIPTION AND POLICY CONTROL

(71) Applicant: Apple Inc., Cupertino, CA (US)

(72) Inventors: Xiaowen Sun, Cupertino, CA (US); Huarui Liang, Cupertino, CA (US); Dawei Zhang, Cupertino, CA (US); Haijing Hu, Cupertino, CA (US); Xiaoyu Qiao, Cupertino, CA (US); Shu Guo, Cupertino, CA (US); Lanpeng Chen, Cupertino, CA (US)

(73) Assignee: Apple Inc., Cupertino, CA (US)

(21) Appl. No.: 19/551,484

(22) Filed: Feb. 26, 2026

Related U.S. Application Data
(60) Provisional application No. 63/778,098, filed on Mar. 26, 2025.

(51) Int. Cl. H04W 52/02

(52) U.S. Cl. CPC H04W 52/0212

(57) ABSTRACT

The present application relates to devices and components including apparatus, systems, and methods to provide energy related subscription and policy control for a user equipment in a wireless system.

### CROSS-REFERENCE TO RELATED APPLICATION

This application claims the benefit of U.S. Provisional Patent Application No. 63/778,098, filed on Mar. 26, 2025, which is herein incorporated by reference in its entirety for all purposes.

### TECHNICAL FIELD

The present application relates to the field of wireless technologies and, in particular, to energy related subscription and policy control for a user equipment.

### BACKGROUND

Third Generation Partnership Project (3GPP) networks provide services to user equipments (UEs). For example, a network can communicate with the UEs to provide services for the UEs. In many instances, the UEs are devices that rely on batteries for powering the UEs, where the batteries often have limited power. Operations performed between the network and the UEs can drain power from the battery, which can cause the UE to turn off when the battery has been drained to a certain level.

### BRIEF DESCRIPTION OF THE DRAWINGS

FIG. 1 illustrates a network environment in accordance with some embodiments.

FIG. 2 illustrates a user equipment in accordance with some embodiments.

FIG. 3 illustrates a network device in accordance with some embodiments.

FIG. 4 illustrates an example non-roaming architecture for energy efficiency and energy saving in accordance with some embodiments.

FIG. 5 illustrates an example non-roaming architecture for energy efficiency and energy saving in reference point representation in accordance with some embodiments.

FIG. 6 illustrates an example system procedure arrangement in accordance with some embodiments.

FIG. 7 illustrates an example system procedure arrangement in accordance with some embodiments.

FIG. 8 illustrates an example system procedure arrangement in accordance with some embodiments.

FIG. 9 illustrates an example system procedure arrangement in accordance with some embodiments.

FIG. 10 illustrates an example system procedure arrangement in accordance with some embodiments.

FIG. 11 illustrates an example system procedure arrangement in accordance with some embodiments.

FIG. 12 illustrates an example procedure for indicating an energy saving preference in accordance with some embodiments.

FIG. 13 illustrates an example procedure for identifying an energy saving policy for implementation in accordance with some embodiments.

FIG. 14 illustrates an example procedure for identifying a user equipment (UE) policy for a UE in accordance with some embodiments.

FIG. 15 illustrates an example procedure for identifying an energy saving policy to implement for a UE in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

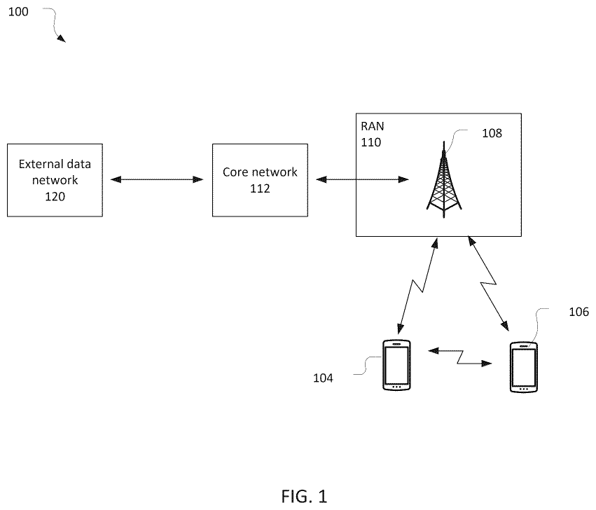

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contain a large amount of data conveying real and virtual images and audio for presentation to a user.

The network environment 100 may further include a core network 112. For example, the core network 112 may comprise a 5^{th} Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

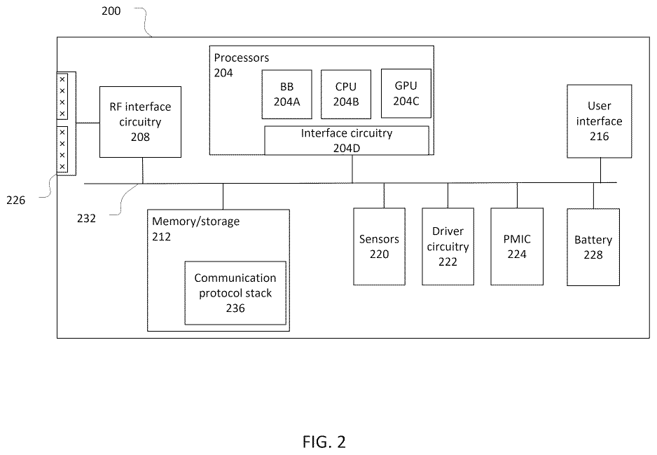

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangements of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

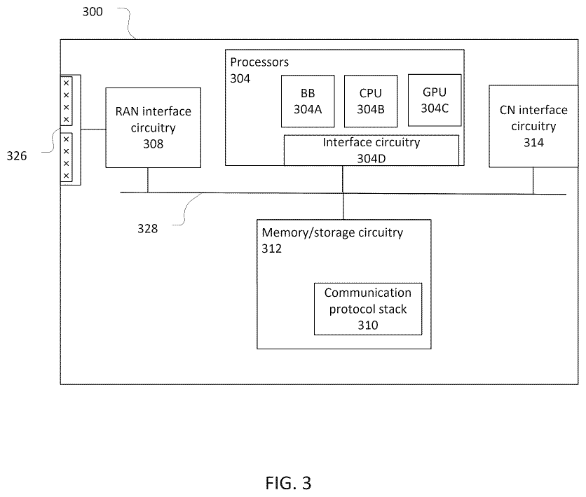

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

Operations described herein as performed by a device (for example, UE 104 (FIG. 1), UE 106 (FIG. 1), or base station 108) may be fully, substantially, or partially performed by processing circuitry implemented on the device.

Example fundamental architecture and related network operation to achieve network energy saving and energy efficiency may include a new network functionality that is defined to collect and calculate the energy related information, and exposes to the authorized consumer subject to operator's policy. The consumer network functions (NFs), including fifth generation core (5GC) NFs and/or application functions (Afs), may request the energy consumption information exposure with reporting request, for example periodic reporting or threshold based reporting. The definition of energy saving subscription information per UE that is stored as part of the subscription data in the unified data management (UDM)/user data repository (UDR), may include to assist the network to perform energy saving strategies for the UE.

To support network energy saving and energy efficiency one or more of the following may be implemented. Enhancements of NF discovery and (re-)selection based on energy related information may be implemented in some embodiments. New energy related information and/or existing NF profile parameters in the NF profile to allow an operator to influence NF discovery and selection based on their energy strategy may be implemented in some embodiments. Enhancement on NF discovery and (re-)selection to consider the energy related information from the NF profiles and/or discovery request from the NF consumer may be implemented in some embodiments. Enhancements on existing operations and procedures for energy saving and energy efficiency may be implemented in some embodiments. The optional user plane (UP) path adjustment for a protocol data unit (PDU) session(s) may be specified.

For subscription and policy control, the following may be implemented. The subscription data may include an indication for network energy saving. The policy control function (PCF) may receive the energy related subscription data. Based on the subscription data and potential energy related notifications, the PCF may make policy decisions reusing the existing parameters based on the operator policy.

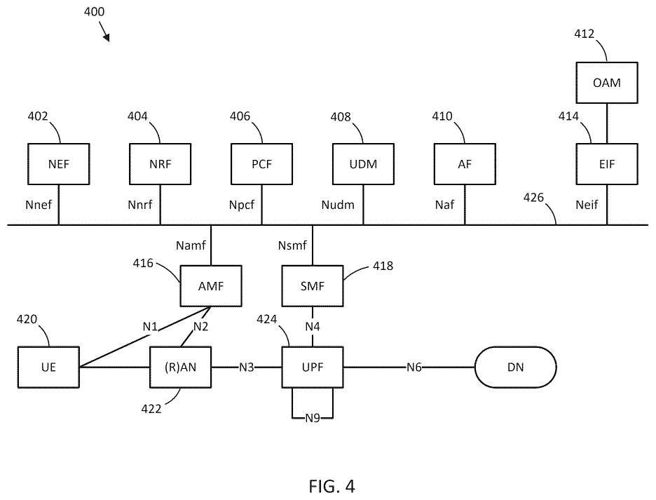

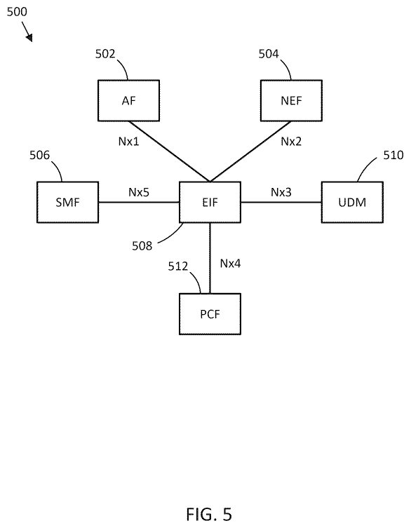

An architecture enhancement may be implemented. Example architectures of energy saving and energy efficiency is illustrated in FIG. 4 and FIG. 5. An energy information function (EIF) may be defined to collect the energy consumption information, calculate the energy consumption information, at the UE, PDU Session, and quality of service (QoS) flow granularity, and/or store the energy consumption information if applicable and expose the energy consumption information to the authorized consumer NF(s) subject to operator's policy.

FIG. 4 illustrates an example non-roaming architecture 400 for energy efficiency and energy saving in accordance with some embodiments. The architecture 400 may include an EIF 414. The EIF 414 may collect the energy consumption information and calculate the energy consumption information. The EIF 414 may determine the energy consumption information at UEs, PDU sessions, and/or QoS flow granularities. The EIF 414 may store the energy consumption information and share information with authorized NFs.

The EIF 414 may be coupled between an OAM 412 and a bus 426. The bus 426 may be coupled to a network exposure function (NEF) 402, a network repository function (NRF) 404, a PCF 406, a UDM 408, an AF 410, an access mobility management function (AMF) 416, and session management function (SMF) 418. The EIF 414 may share information (including the energy consumption information) with the AMF 416, the SMF 418, the PCF 406, the UDM 408, and/or the AF 410. In other embodiments, the EIF 414 may share information with any one or more of the NFs coupled to the bus 426.

The AMF 416 may be coupled to a UE 420 and a base station 422 (which may be referred to as an access node or a radio access node). The UE 420 may include one or more of the features of the UE 104 (FIG. 1), the UE 106 (FIG. 1), and/or the UE 200 (FIG. 2). The base station 422 may include one or more of the features of the base station 108 (FIG. 1) and/or the network device 300 (FIG. 3). Further, a connection may be established between the UE 420 and the base station 422.

The SMF 418 may be coupled to the user plane function (UPF) 424. The UPF 424 may be coupled to the base station 422.

FIG. 5 illustrates an example non-roaming architecture 500 for energy efficiency and energy saving in reference point representation in accordance with some embodiments. The architecture 500 may include an EIF 508. The EIF 508 may collect the energy consumption information and calculate the energy consumption information. The EIF 508 may determine the energy consumption information at UEs, PDU sessions, and/or QoS flow granularities. The EIF 508 may store the energy consumption information and share information with authorized NFs.

The EIF 508 may be coupled to an AF 502, an NEF 504, an SMF 506, a UDM 510, and/or a PCF 512. The EIF 508 may share information (including the energy consumption information) with the AF 502, the NEF 504, the SMF 506, the UDM 510, and/or the PCF 512.

The legacy fifth generation (5G) system may be enhanced to provide indication of network energy saving and update the PCF interaction to receive the energy related subscription data. What parameters related to energy saving may be added in the UE subscription data is not clear in the legacy system. The details of policy decision when PCF obtained energy related notification is not designed in the legacy 5G system. It is possible other networks functions may also receive the energy related information and influence the corresponding network procedures. The corresponding network procedures may include a registration procedure, a PDU session establishment procedure, and/or a UE configuration update procedure.

An approach includes a design for the 5G network to support energy related subscription and policy control. Applicable use cases may include 1) registration/PDU session establishment procedure update to retrieve energy subscription, 2) access and mobility management (AM)/session management (SM) policy association by considering energy efficiency (EE) information, and/or 3) UE policy update by considering EE information. The subject matter described herein may be utilized for energy efficiency and energy saving (EnergySys). The approaches described herein may further be implemented in other systems, including sixth generation (6G) systems and/or other 3GPP network systems.

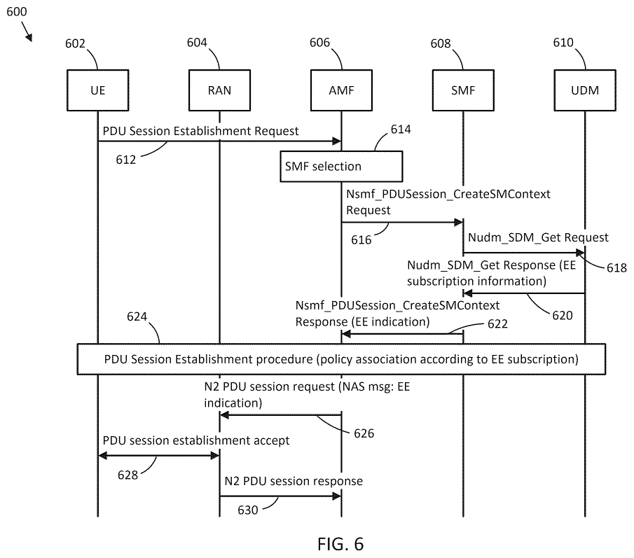

FIG. 6 illustrates an example system procedure arrangement 600 in accordance with some embodiments. The system procedure arrangement 600 illustrates an example first approach for implementing energy savings for a UE. The first approach may include implementing a session management function (SMF) receive energy saving indication from UDM.

The arrangement 600 may include a UE 602. The UE 602 may include one or more of the features of the UE 104 (FIG. 1), the UE 106 (FIG. 1), and/or the UE 200 (FIG. 2). Further, the arrangement 600 may include a base station 604. The base station 604 may include one or more of the features of the base station 108 (FIG. 1) and/or the network device 300 (FIG. 3). The base station 604 may be referred to as a radio access network (RAN) or an access node in some instances.

The arrangement 600 may include an AMF 606. The AMF 606 may be a control plane function in a network. The AMF 606 may be part of a core network. The AMF 606 may handle connection and management mobility tasks of the network.

The arrangement 600 may include a session management function (SMF) 608. The SMF 608 may be part of the core network. The SMF 608 may collect information related to PDU session management from various network components. For example, the SMF 608 may collect information from a UPF, a PCF, and/or a UDM 610. The SMF 608 may control the network components based on requests from the AMF.

The arrangement 600 may include a UDM 610. The UDM 610 may be part of the core network. The UDM 610 may manage user data.

The UE 602 may initiate a procedure illustrated by the arrangement 600 by generating and/or transmitting a PDU session establishment request to the AMF 606 in 612. The UE 602 may request to establish a PDU session. Optionally, if the UE 602 desires to achieve energy saving and energy efficiency, or the UE 602 is in low battery status (UE low battery mode is activated), the UE 602 may include an energy saving indication in the PDU session establishment request. For example, the UE 602 may detect an energy saving trigger. The energy saving trigger may be an indication that the UE 602 desires to achieve energy saving and energy efficiency, the UE 602 is in a low battery status, a charge of a battery of the UE 602 is below a threshold level, and/or an energy saving setting of the UE 602 is set to activated. If the UE 602 has detected the energy saving trigger, the UE 602 may generate an energy saving indication to include in the PDU session establishment request in 612.

The AMF 606 may identify the PDU session establishment request received from the UE 602. The AMF 606 may select the SMF 608 in 614.

The AMF 606 may send an Nsmf_PDUSession_CreateSMContext request to the selected SMF 608 in 616. For example, the AMF 606 may generate and/or transmit a PDU session create SM context request (Nsmf_PDUSession_CreateSMContext request) to the SMF 608 in 616. Optionally, if energy saving indication is provided in the initial request in 612, the indication may also be included in the AMF request. For example, the AMF 606 may include the energy saving indication from the PDU session establishment request in the PDU session create SM context request in 616.

The SMF 608 may retrieve UE subscription information through Nudm_SDM_get request in 618. For example, the SMF 608 may identify the PDU session create SM context request. The SMF 608 may generate and/or transmit a session data management (SDM) get request (Nudm_SDM_Get request) to the UDM 610 in 618.

The UDM 610 may respond with the UE subscription information to the SMF in 620. For example, the UDM 610 may identify the SDM get request received from the SMF 608. The UDM 610 may generate and/or transmit an SDM get response (Nudm_SDM_Get response) to the SMF 608 in 620. The SDM get response may include EE subscription information. The EE subscription information may be for the UE 602. For including energy efficiency and energy saving information in the UE subscription, there are different possibilities on the UDM 610 provided subscription information. For example, the following possibilities provide information that may be included in the EE subscription information in the SDM get response.

A first possibility may be an indication that the UE 602 has subscribed to an energy saving service, which means all the single network slice selection assistance information (S-NSSAI), non-public networks (NPNs) . . . that the UE 602 has subscribed may need to realize energy saving, and the corresponding network function selection, policy decision may need to consider energy related information. For example, the EE subscription information may include an indication that the UE 602 has subscribed to the energy saving service. The indication may indicate that S-NSSAI and/or NPNs to which the UE 602 is subscribed are to realize energy saving, or that the UE is subscribed to realize energy saving, which means all the services to which the UE is subscribed are to realize energy saving. Based on the indication, the corresponding network function selection and/or policy decision may consider energy related information.

A second possibility may be, for specific network slice(s), subscribed S-NSSAI(s), or NPN(s), the network may provide the UE 602 energy saving service. For example, the EE subscription may indicate specific network slices, subscribed S-NSSAIs and/or NPNs for which the network is to provide energy saving services.

A third possibility may include an energy saving threshold, e.g., when the energy consumption of the UE 602 or specific S-NSSAI(s) . . . exceed or lower than specific value, the network may activate/de-activate the energy saving control. For example, the EE subscription information may include an indication of an energy saving threshold. When the energy consumption of the UE 602 and/or specific NSSAIs exceed or are lower than the energy saving threshold, the energy saving control may be activated or de-activated. For example, the energy saving control may be activated when the energy consumption is lower than the energy saving threshold and may be de-activated when the energy consumption exceeds the energy saving threshold.

A fourth possibility may include a UE subscribed energy credit limit for whole UE or for specific S-NSSAI(s), NPN(s), (which means, UE has subscribed the total energy usage value for whole UE or for specific S-NSSAI(s), NPN(s), application services . . . ). For example, the EE subscription information may include a UE subscribed energy credit limit. The UE subscribed energy credit limit may be for the UE 602, specific S-NSSAIs, and/or specific NPNs.

While the third possibility and the fourth possibility look similar, the difference may be that the threshold is set by network carrier, and credit limit is subscribed by the user, so the UE 602 is aware of the credit limit value. For example, the energy saving threshold in the third possibility may be set by the network and/or a network carrier. The UE subscribed energy credit limit may be defined by a user of the UE 602, a subscription of the UE 602, and/or a subscription of a user of the UE 602.

The SMF 608 may include the UE subscription information as described in 620 to the AMF 606 in 622. For example, the SMF 608 may generate and/or transmit a PDU session create context response (Nsmf_PDUSession_CreateSMContext Response) to the AMF in 622. The SMF 608 may include an EE indication, corresponding to the EE subscription information received in the SDM get response in 620, in the PDU session create context response.

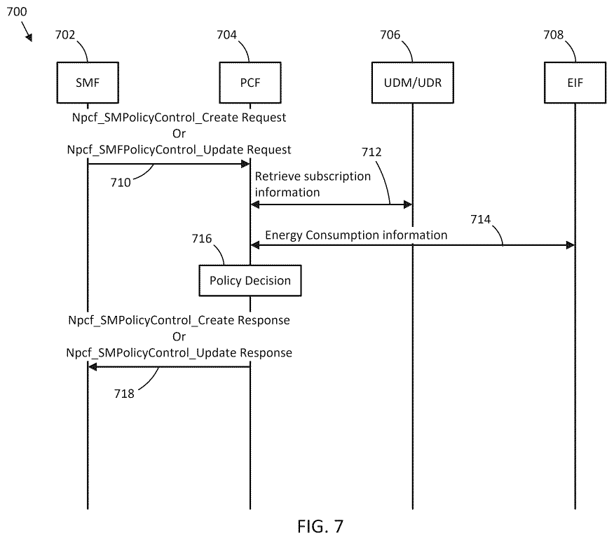

The corresponding PDU session establishment procedure may be performed in 624. For example, the AMF 606 may identify the PDU session create context response received from the SMF 608. A PDU session establishment procedure may be initiated in 624. During SM policy association establishment procedure or SM policy association modification procedure, if the UE 602 has subscribed to energy saving service, the SMF 608 may provide energy saving indication to a PCF to obtain energy saving related services. An example of the corresponding procedure is illustrated in FIG. 7. The energy saving policy provided from the PCF to the SMF 608 may have a different QoS policy.

In case for RAN energy saving control, the UE subscription information may influence the base station's 604 decision on energy saving. The AMF 606 may provide the energy saving information e.g., indication that the UE 602 has subscribed energy saving service for all the UE service or for specific services identified by S-NSSAI, NPN identifier (ID) . . . , to the base station 604 in an N2 PDU session request. For example, the AMF 606 may generate and/or transmit an N2 PDU session request to the base station 604 in 626. The AMF 606 may include the EE indication in the N2 PDU session request. The EE indication may indicate that the UE 602 has subscribed to the energy saving service for all services of the UE 602 and/or specific services, the specific services identified by S-NSSAI and/or NPN ID.

The base station 604 may perform some energy control after receiving the indication. For example, the base station 604 may identify the N2 PDU session request received from the AMF 606. The base station 604 may perform some energy control based on identifying the EE indication in the N2 PDU session request.

PDU session establishment accept information may be provided to the UE 602 in 628. For example, the base station 604 may generate and/or transmit a message to the UE 602, where the message may include PDU session establishment accept information.

An N2 PDU session response may be provided in 630. The base station 604 may notify the AMF 606 that it has performed energy saving control for the UE 602. For example, the base station 604 may generate and/or transmit an N2 PDU session response to the AMF 606 in 630. The N2 PDU session response may indicate that the base station 604 has implemented an energy saving policy for the UE 602.

FIG. 7 illustrates an example system procedure arrangement 700 in accordance with some embodiments. The system procedure arrangement 700 illustrates a first option of the first approach (which may be referred to as approach 1-1). The first option may include an SM Policy control according to UE subscription information.

The arrangement 700 may include an SMF 702. The SMF 702 may include one or more of the features of the SMF 608 (FIG. 6). The SMF 702 may be part of a core network.

The arrangement 700 may include a PCF 704. The PCF 704 may be part of the core network. The PCF 704 may provide policy rules for control plane functions, and/or subscription information for policy decisions. Further, the PCF 704 may further support policy and charging control functions.

The arrangement 700 may include a UDM/UDR 706 (which can be referred to as UDM 706). The UDM 706 may be part of the core network. The UDM 706 may include one or more of the functions of the UDM 610 (FIG. 6). Further, the UDM 706 (in particular, the UDR part of the UDM 706) may store subscription data and/or subscriber policy data. The UDM 706 may also store session data, context data, and/or application state data in some embodiments.

The arrangement 700 may include an EIF 708. The EIF 708 may be part of the core network. The EIF 708 may include one or more of the features of the EIF 414 (FIG. 4) and/or the EIF 508 (FIG. 5).

The SMF 702 may have determined to establish an SM policy association by Npcf_SMPolicyControl_Create request, or update the SM policy association by Npcf_SMPolicyControl_Update request in 710. For example, the SMF 702 may determine to establish an SM policy association. In some instances, the SMF 702 may generate and/or transmit a policy control create request (Npcf_SMPolicyControl_Create request) to the PCF 704 in 710. In other instances, the SMF 702 may generate and/or transmit a policy control update request (Npcf_SMFPolicyControl_Update request) to the PCF 704 in 710. If the SMF 702 receives the EE indication, the SMF 702 may include it in the request. For example, the SMF 702 may identify a received EE indication (such as the EE subscription information received in 620 (FIG. 6)). Based on identifying the EE indication, the SMF 702 may include the EE indication in the policy control create request and/or policy control update request.

If the PCF 704 does not have the subscriber's subscription information, the PCF 704 may request the UDM/UDR 706 to provide the subscription information related to the UE (such as the UE 602 (FIG. 6)) and/or the PDU session in 712. For example, the PCF 704 may identify the policy control create request and/or the policy control update request received from the SMF 702. If the PCF 704 does not have subscription information for the UE, the PCF 704 may retrieve subscription information from the UDM 706 in 712, the subscription information related to the UE. The UDM/UDR 706 may provide the energy saving related subscription information in 712. For example, the UDM 706 may generate and/or transmit a message to the PCF 704 in 712, where the message includes energy saving related subscription information related to the UE.

Optionally, if the PCF 704 has subscribed to the PDU session level or UE level energy consumption from the EIF 708, the EIF 708 provided energy consumption information may include at least one parameter the PCF 704 may consider when deciding the policy. For example, the PCF 704 may retrieve energy consumption information from the EIF 708 in 714. The EIF 708 may generate and/or transmit a message to the PCF 704 in 714, the message including energy consumption information. The energy consumption information may include one or more parameters that the PCF 704 may consider when making a policy decision for the UE.

Based on the energy subscription information, the PCF 704 may make the policy decision in 716. Energy related information can be the only one parameter the PCF 704 may consider to make decisions, or it can be one of the factors that the PCF 704 may make the decision. The PCF 704 may also consider other information. For example, the PCF 704 may make a policy decision in 716, where the policy decision may result in an energy saving policy and/or an SM policy being determined for the UE. The PCF 704 may make the policy decision based on one or more factors, such as information from the subscription information retrieved in 712 and/or the energy consumption information retrieved in 714. In some instances, the PCF 704 may make the policy decision based further on one or more factors utilized for making policy decisions by PCFs in legacy embodiments.

The generated or updated SM policy may be provided to the SMF 702 in 718. For example, the PCF 704 may generate and/or transmit a policy control create response (Npcf_SMPolicyControl_Create response) to the SMF 702 in 718 in some instances, where the policy control create response may include the energy saving policy and/or the SM policy determined in 716. In other instances, the PCF 704 may generate and/or transmit a policy control update response (Npcf_SMPolicyControl_Update response) to the SMF 702 in 718, where the policy control update response may include the energy saving policy and/or the SM policy determined in 716. Here the policy may have different possibilities. The possibilities may include a different QoS, modifying the QoS when energy usage exceeds the energy credit limit, energy saving policy activated time window (start time, end time), and/or energy policy validity information (time, location) for when and where to activate the energy saving policy.

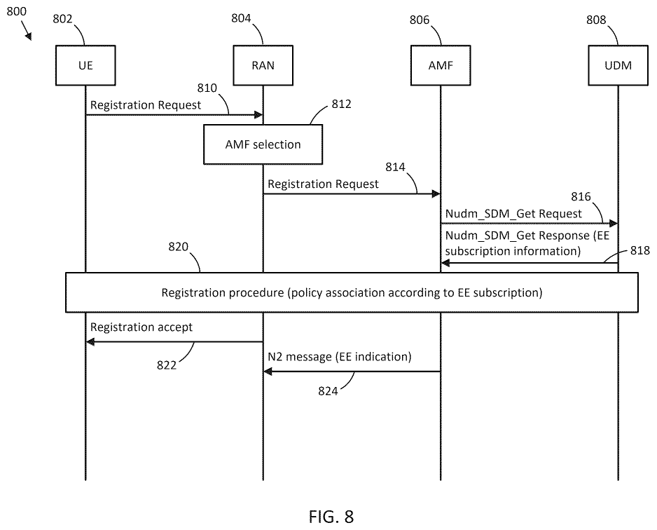

FIG. 8 illustrates an example system procedure arrangement 800 in accordance with some embodiments. The system procedure arrangement 800 illustrates an example second approach for implementing energy savings for a UE. The second option may include implementing an AMF receive energy saving indication from UDM.

The arrangement 800 may include a UE 802. The UE 802 may include one or more of the features of the UE 104 (FIG. 1), the UE 106 (FIG. 1), and/or the UE 200 (FIG. 2). Further, the arrangement 800 may include a base station 804. The base station 804 may include one or more of the features of the base station 108 (FIG. 1) and/or the network device 300 (FIG. 3). The base station 804 may be referred to as a radio access network (RAN) or an access node in some instances.

The arrangement 800 may include an AMF 806. The AMF 806 may be a control plane function in a network. The AMF 806 may be part of a core network. The AMF 806 may handle connection and management mobility tasks of the network.

The arrangement 800 may include a UDM 808. The UDM 808 may be part of the core network. The UDM 808 may manage user data.

The UE 802 may send a registration request to the base station 804 in 810. For example, the UE 802 may generate and/or transmit a registration request to the base station 804 in 810. Optionally, if the UE 802 desires to achieve energy saving and energy efficiency, or the UE 802 is in low battery status (UE low battery mode is activated), the UE 802 may include an energy saving indication in the registration request. For example, the UE 802 may detect an energy saving trigger. The energy saving trigger may be an indication that the UE 802 desires to achieve energy saving and energy efficiency, the UE 802 is in a low battery status, a charge of a battery of the UE 802 is below a threshold level, and/or an energy saving setting of the UE 802 is set to activated. If the UE 802 has detected the energy saving trigger, the UE 802 may generate an energy saving indication to include in the registration request in 810.

The base station 804 may select the AMF 806 in 812. For example, the base station 804 may identify the registration request received from the UE 802. The base station 804 may select the AMF 806 in the AMF selection in 812.

The base station 804 may send the registration request to the AMF 806 in 814. For example, the base station 804 may forward the registration request received from the UE 802 to the AMF 806 in 814. If the EE indication is included in registration request in 810, it will also be provided to the AMF 806 in 814.

The AMF 806 may retrieve the UE subscription information through Nudm_SDM_get request in 816. For example, the AMF 806 may identify the registration request received from the base station 804. The AMF 806 may generate and/or transmit an SDM get request (Nudm_SDM_Get request) to the UDM 808 in 816. The SDM get request may request UE subscription information for the UE 802 from the UDM 808.

The UDM may respond with the UE subscription information to the AMF 806 in 818. For example, the UDM 808 may identify the SDM get request received from the AMF 806. The UDM 808 may generate and/or transmit an SDM get response to the AMF 806 in 818, where the SDM get response may include the UE subscription information for the UE 802. For including energy efficiency and energy saving information in the UE subscription, there are different possibilities on the UDM 808 provided subscription information. For example, the following possibilities provide information that may be included in the EE subscription information in the SDM get response.

A first possibility may be an indication that the UE 802 has subscribed to an energy saving service, which means all the single network slice selection assistance information (S-NSSAI), non-public networks (NPNs)... that the UE 802 has subscribed may need to realize energy saving, and the corresponding network function selection, policy decision may need to consider energy related information. For example, the EE subscription information may include an indication that the UE 802 has subscribed to the energy saving service. The indication may indicate that S-NSSAI and/or NPNs to which the UE 802 is subscribed are to realize energy saving, or that the UE is subscribed to realize energy saving, which means that all of the services to which the UE is subscribed are to realize energy saving. Based on the indication, the corresponding network function selection and/or policy decision may consider energy related information.

A second possibility may be, for specific network slice(s), subscribed S-NSSAI(s), or NPN(s), the network may provide the UE 802 energy saving service. For example, the EE subscription may indicate specific network slices, subscribed S-NSSAIs and/or NPNs for which the network is to provide energy saving services.

A third possibility may include an energy saving threshold, e.g., when the energy consumption of the UE 802 or specific S-NSSAI(s) . . . exceed or lower than specific value, the network may activate/de-activate the energy saving control. For example, the EE subscription information may include an indication of an energy saving threshold. When the energy consumption of the UE 802 and/or specific NSSAIs exceed or are lower than the energy saving threshold, the energy saving control may be activated or de-activated. For example, the energy saving control may be activated when the energy consumption is lower than the energy saving threshold and may be de-activated when the energy consumption exceeds the energy saving threshold.

A fourth possibility may include a UE subscribed energy credit limit for whole UE or for specific S-NSSAI(s), NPN(s), (which means, UE has subscribed the total energy usage value for whole UE or for specific S-NSSAI(s), NPN(s), application services . . . ). For example, the EE subscription information may include a UE subscribed energy credit limit. The UE subscribed energy credit limit may be for the UE 802, specific S-NSSAIs, and/or specific NPNs.

While the third possibility and the fourth possibility look similar, the difference may be that the threshold is set by network carrier, and credit limit is subscribed by the user, so the UE 802 is aware of the credit limit value. For example, the energy saving threshold in the third possibility may be set by the network and/or a network carrier. The UE subscribed energy credit limit may be defined by a user of the UE 802, a subscription of the UE 802, and/or a subscription of a user of the UE 802.

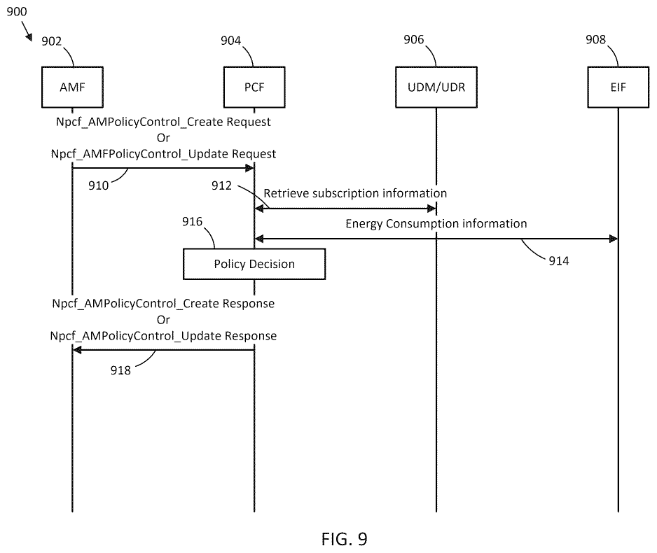

The corresponding PDU session establishment procedure may be performed in 820. For example, the AMF 806 may identify the SDM get response received from the UDM 808. A PDU session establishment procedure may be initiated in 820. During AM policy association establishment procedure or AM policy association modification procedure, if UE has subscribed to energy saving service, the AMF 806 may provide energy saving indication to a PCF to obtain energy saving related services. An example of the corresponding procedure is illustrated in FIG. 9. The energy saving policy provided from the PCF to the AMF 806 may be a different radio access technology/frequency selection priority (RFSP) index.

The base station 804 may provide a registration accept to the UE 802 in 822. For example, the base station 804 may generate and/or transmit a registration accept to the UE in 822. In case for RAN energy saving control, the UE subscription information may influence the base station's 804 decision on energy saving, The AMF 806 may provide the energy saving information, e.g., indication that UE has subscribed energy saving service for all the UE service or for specific services identified by S-NSSAI, NPN ID . . . , to RAN in the N2 message after registration. For example, the AMF 806 may generate and/or transmit an N2 message to the base station 804 in 824. The AMF 806 may include the EE subscription information in the N2 message. The EE subscription information may indicate that the UE 802 has subscribed to the energy saving service for all services of the UE 802 and/or specific services, the specific services identified by S-NSSAI and/or NPN ID.

FIG. 9 illustrates an example system procedure arrangement 900 in accordance with some embodiments. The system procedure arrangement 900 illustrates a first option of the second approach (which may be referred to as approach 2-1). The first option of the second approach may include SM Policy Control according to UE subscription information.

The arrangement 900 may include an AMF 902. The AMF 902 may include one or more of the features of the AMF 806 (FIG. 8). The AMF 902 may be part of a core network.

The arrangement 900 may include a PCF 904. The PCF 904 may be part of the core network. The PCF 904 may provide policy rules for control plane functions, and/or subscription information for policy decisions. Further, the PCF 904 may further support policy and charging control functions.

The arrangement 900 may include a UDM/UDR 906 (which can be referred to as UDM 906). The UDM 906 may be part of the core network. The UDM 906 may include one or more of the functions of the UDM 808 (FIG. 8). Further, the UDM 906 (in particular, the UDR part of the UDM 906) may store subscription data and/or subscriber policy data. The UDM 906 may also store session data, context data, and/or application state data in some embodiments.

The arrangement 900 may include an EIF 908. The EIF 908 may be part of the core network. The EIF 908 may include one or more of the features of the EIF 414 (FIG. 4) and/or the EIF 508 (FIG. 5).

The AMF 902 may have determined to establish an AM policy association by Npcf_AMPolicyControl_Create request, or update the AM policy association by Npcf_AMPolicyControl_Update request in 910. For example, the AMF 902 may determine to establish an AM policy association. In some instances, the AMF 902 may generate and/or transmit a policy control create request (Npcf_AMPolicyControl_Create request) to the PCF 904 in 910. In other instances, the AMF 902 may generate and/or transmit a policy control update request (Npcf_AMPolicyControl_Update request) to the PCF 904 in 910. If the AMF 902 receives the EE indication, the AMF 902 may include it in the request. For example, the AMF 902 may identify a received EE indication (such as the EE subscription information received in 918 (FIG. 9)). Based on identifying the EE indication, the AMF 902 may include the EE indication in the policy control create request and/or policy control update request.

If the PCF 904 does not have the subscriber's subscription information, the PCF 904 may request the UDM/UDR 906 to provide the subscription information related to the UE (such as the UE 802 (FIG. 8)) and/or the PDU session in 912. For example, the PCF 904 may identify the policy control create request and/or the policy control update request received from the AMF 902. If the PCF 904 does not have subscription information for the UE, the PCF 904 may retrieve subscription information from the UDM 906 in 912, the subscription information related to the UE. The UDM/UDR 906 may provide the energy saving related subscription information in 912. For example, the UDM 906 may generate and/or transmit a message to the PCF 904 in 919, where the message includes energy saving related subscription information related to the UE.

Optionally, if the PCF 904 has subscribed to the PDU session level or UE level energy consumption from the EIF 908, the EIF 908 provided energy consumption information may include at least one parameter the PCF 904 may consider when deciding the policy. For example, the PCF 904 may retrieve energy consumption information from the EIF 908 in 914. The EIF 908 may generate and/or transmit a message to the PCF 904 in 914, the message including energy consumption information. The energy consumption information may include one or more parameters that the PCF 904 may consider when making a policy decision for the UE.

Based on the energy subscription information, the PCF 904 may make the policy decision in 916. Energy related information can be the only one parameter the PCF 904 may consider to make decisions, or it can be one of the factors that the PCF 904 may make the decision. The PCF 904 may also consider other information. For example, the PCF 904 may make a policy decision in 916, where the policy decision may result in an energy saving policy and/or an AM policy being determined for the UE. The PCF 904 may make the policy decision based on one or more factors, such as information from the subscription information retrieved in 912 and/or the energy consumption information retrieved in 914. In some instances, the PCF 904 may make the policy decision based further on one or more factors utilized for making policy decisions by PCFs in legacy embodiments.

The generated or updated AM policy may be provided to the AMF 902 in 918. For example, the PCF 904 may generate and/or transmit a policy control create response (Npcf_AMPolicyControl_Create response) to the AMF 902 in 918 in some instances, where the policy control create response may include the energy saving policy and/or the AM policy determined in 916. In other instances, the PCF 904 may generate and/or transmit a policy control update response (Npcf_AMPolicyControl_Update response) to the AMF 902 in 918, where the policy control update response may include the energy saving policy and/or the AM policy determined in 916. Here the policy may have different possibilities. The possibilities may include a different RFSP index, triggering AMF re-location when energy usage exceeds the energy credit limit, energy saving policy activated time window (start time, end time), and/or energy policy validity information (time, location) for when and where to activate the energy saving policy.

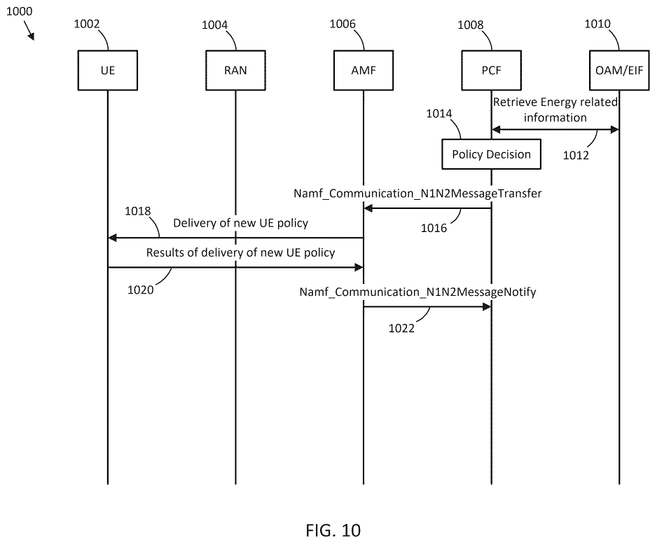

FIG. 10 illustrates an example system procedure arrangement 1000 in accordance with some embodiments. The system procedure arrangement 1000 illustrates a third approach for implementing energy savings for a UE. The third approach may include implementing a UE configuration update by considering energy related information.

The arrangement 1000 may include a UE 1002. The UE 1002 may include one or more of the features of the UE 104 (FIG. 1), the UE 106 (FIG. 1), and/or the UE 200 (FIG. 2). Further, the arrangement 1000 may include a base station 1004. The base station 1004 may include one or more of the features of the base station 108 (FIG. 1) and/or the network device 300 (FIG. 3). The base station 1004 may be referred to as a radio access network (RAN) or an access node in some instances.

The arrangement 1000 may include an AMF 1006. The AMF 1006 may be a control plane function in a network. The AMF 1006 may be part of a core network. The AMF 1006 may handle connection and management mobility tasks of the network.

The arrangement 1000 may include a PCF 1008. The PCF 1008 may be part of the core network. The PCF 1008 may provide policy rules for control plane functions, and/or subscription information for policy decisions. Further, the PCF 1008 may further support policy and charging control functions.

The arrangement 1000 may include an OAM/EIF 1010 (which may be referred to as an EIF 1010. The EIF 1010 may include one or more of the features of the EIF 414 (FIG. 4) and/or the EIF 508 (FIG. 5).

The PCF 1008 may obtain energy consumption information at different granularity from the OAM/EIF 1010 in 1012. For example, the PCF 1008 may generate and/or transmit a message to the EIF 1010 in 1012, where the message includes a request for energy consumption information. The EIF 1010 may identify the message received from the PCF 1008. The EIF 1010 may generate a response, where the response includes energy consumption information. The granularity retrieved from the OAM of the EIF 1010 may include NF level, network slice level, and/or network node level (core network (CN) level, RAN level) energy consumption information. The granularity retrieved from the EIF of the EIF 1010 may include PDU session level, UE level, and/or application level energy consumption information.

The PCF 1008 may make policy decision based on different parameters in 1014, the energy related information is one of the parameters that may be considered. Energy related information can be the only one parameter the PCF 1008 may consider to make decisions, or it can be one of the factors that the PCF 1008 may make the decision. The PCF 1008 may also consider other information. For example, the PCF 1008 may make a policy decision in 1014, where the policy decision may result in an energy saving policy and/or a UE policy being determined for the UE 1002. The PCF 1008 may make the policy decision based on one or more factors, such as information from the energy consumption information retrieved in 1012. In some instances, the PCF 1008 may make the policy decision based further on one or more factors utilized for making policy decisions by PCFs in legacy embodiments. The newly defined UE policy may be a new UE route selection policy (URSP), for example, a new data network name (DNN)/network slice selection assistance information (NSSAI) which has low energy consumption configured in the UE 1002.

The PCF 1008 may invoke Namf_Communication_N1N2MessageTransfer to provide the new UE policy to the AMF 1006 in 1016. For example, the PCF 1008 may generate and transmit a message transfer (Namf_Communication_N1N2MessageTransfer) to the AMF 1006 in 1016. The message transfer may include an indication of the energy saving policy and/or the UE policy determined in 1014.

The AMF 1006 may transfer the UE policy to the UE 1002 in 1018. For example, the AMF 1006 may identify the message transfer received in the PCF 1008 and identify the indication of the energy saving policy and/or the UE policy in the message transfer. The AMF 1006 may generate and/or transmit a message to the UE 1002 in 1018, where the message includes the indication of the energy saving policy and/or the UE policy.

The UE 1002 may update the UE policy and may send results to the AMF 1006 in 1020. For example, the UE 1002 may identify the indication of the energy saving policy and/or the UE policy received in the message from the AMF 1006. The UE 1002 may perform a policy update to implement the energy saving policy and/or the UE policy. The UE 1002 may generate and/or transmit a response to the AMF 1006 in 1020, where the response indicates a result of the policy update.

The AMF 1006 may forward the response to the PCF 1008 in 1020. For example, the AMF 1006 may identify the response received from the UE 1002. The AMF 1006 may generate and/or transmit a message notify (Namf_Communication_N1N2MessageNotify) to the PCF 1008 in 1022, wherein the message notify includes the response.

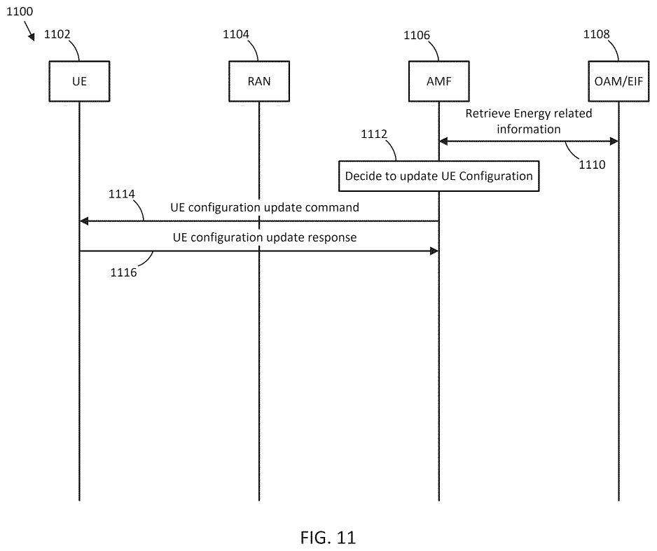

FIG. 11 illustrates an example system procedure arrangement 1100 in accordance with some embodiments. The system procedure arrangement 1100 illustrates a first option of the third approach (which may be referred to as approach 3-1). The first option of third approach may include an AMF triggered UE configuration update by considering energy related information.

The arrangement 1100 may include a UE 1102. The UE 1102 may include one or more of the features of the UE 104 (FIG. 1), the UE 106 (FIG. 1), and/or the UE 200 (FIG. 2). Further, the arrangement 1100 may include a base station 1104. The base station 1104 may include one or more of the features of the base station 108 (FIG. 1) and/or the network device 300 (FIG. 3). The base station 1104 may be referred to as a radio access network (RAN) or an access node in some instances.

The arrangement 1100 may include an AMF 1106. The AMF 1106 may be a control plane function in a network. The AMF 1106 may be part of a core network. The AMF 1106 may handle connection and management mobility tasks of the network.

The arrangement 1100 may include an OAM/EIF 1108 (which may be referred to as an EIF 1108. The EIF 1108 may include one or more of the features of the EIF 414 (FIG. 4) and/or the EIF 508 (FIG. 5).

The AMF 1106 may obtain energy consumption information at different granularity from the OAM/EIF 1108 in 1110. For example, the AMF 1106 may generate and/or transmit a message to the EIF 1108 in 1110, where the message includes a request for energy consumption information. The EIF 1108 may identify the message received from the AMF 1106. The EIF 1108 may generate a response, where the response includes energy consumption information. The granularity retrieved from the OAM of the EIF 1108 may include NF level, network slice level, and/or network node level (core network (CN) level, RAN level) energy consumption information. The granularity retrieved from the EIF of the EIF 1108 may include PDU session level, UE level, and/or application level energy consumption information.

The AMF 1106 may determine the necessity of UE configuration change due to various reasons in 1112. For example, the AMF 1106 may identify the energy consumption information received in 1110. The AMF 1106 may determine whether a UE configuration of the UE 1102 is to be changed due to various reasons, including reasons based on the energy consumption information. For energy saving reason, if different network slice energy consumption received from the OAM of the EIF 1108 are not the same, and the current network has more than one network slice (i.e., S-NSSAIs to service the UE's 1102 subscription S-NSSAI/requested S-NSSAI), the AMF 1106 may determine new allowed NSSAI for the UE 1102 for the purpose of energy saving. There may be the possibility that some network slices'energy consumption suddenly reached higher than normal status, for which the AMF 1106 may determine a new allowed NSSAI.

The AMF 1106 may send UE configuration update command containing the newly decided allowed NSSAI in 1114. For example, the AMF 1106 may generate and/or transmit a UE configuration update command to the UE 1102 in 1114. The UE configuration update command may include an indication of the new allowed NSSAI determined in 1112.

The UE 1102 may send a UE configuration update complete message to the AMF 1106 in 1116. For example, the UE 1102 may identify the UE configuration update command received from the AMF 1106. The UE 1102 may further identify the indication of the new allowed NSSAI and perform a UE configuration update to update to the new allowed NSSAI. The UE 1102 may generate and/or transmit a UE configuration update response to the AMF 1106 in 1116, where the UE configuration update response may indicate that the UE has completed the UE configuration update.

In summary, for subscription control, a UDM may provide UE related energy saving subscription information to network functions, to perform further network control. The network control may be to provide to AM-PCF and SM-PCF for policy control and/or to provide to RAN to help RAN do further energy saving control. For energy related policy control, the AM policy, SM policy and/or UE policy may be updated to achieve energy saving and energy efficiency. The UE configuration update may also be enhanced to support energy related network control.

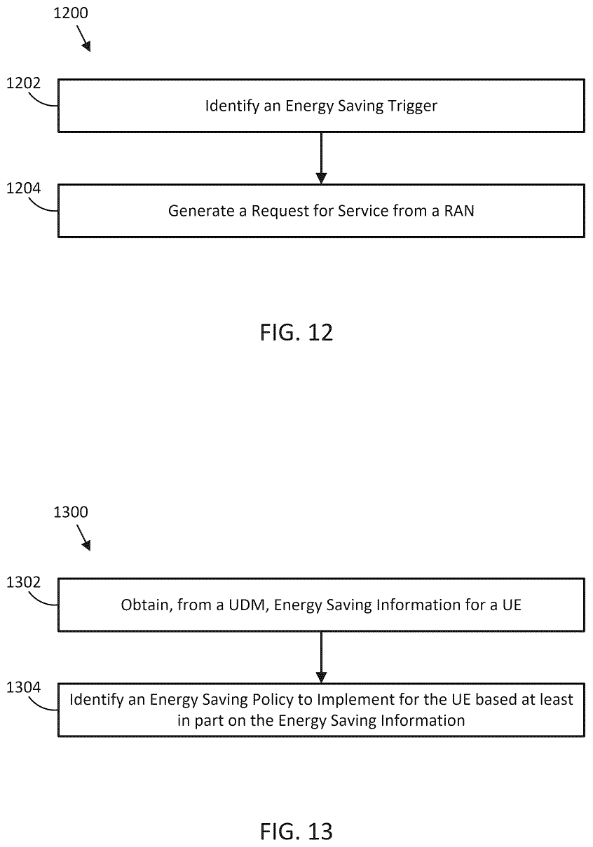

FIG. 12 illustrates an example procedure 1200 for indicating an energy saving preference in accordance with some embodiments. The procedure 1200 may be performed by a UE, such as the UE 104 (FIG. 1), the UE 106 (FIG. 1), and/or the UE 200 (FIG. 2).

The procedure 1200 may include identifying an energy saving trigger in 1202.

The procedure 1200 may include generating a request for service from a radio access network (RAN) in 1204. The request may include an energy saving indication based at least in part on identification of the energy saving trigger. In some embodiments the request may comprise a protocol data unit (PDU) session establishment request. Further, the request may comprise a registration request in some embodiments.

In some embodiments, the procedure 1200 may further include identifying an indication of a user equipment (UE) policy. The UE policy may be identified based at least in part on energy consumption information obtained from an operation, management, administration (OAM) or an energy information function (EIF). In these embodiments, the procedure 1200 may further include updating a current UE policy with the UE policy, and generating an indication of results of updating the current UE policy.

Any one or more of the operations in FIG. 12 may be performed in a different order than shown and/or one or more of the operations may be performed concurrently in embodiments. Further, it should be understood that one or more of the operations may be omitted from and/or one or more additional operations may be added to the procedure 1200 in other embodiments.

FIG. 13 illustrates an example procedure 1300 for identifying an energy saving policy for implementation in accordance with some embodiments. The procedure 1300 may be performed by a base station, such as the base station 108 (FIG. 1) and/or the network device 300 (FIG. 3).

The procedure 1300 may include obtaining, from a unified data management (UDM), energy saving information for a user equipment (UE) in 1302.

In some embodiments, the UDM may identify the energy saving information. In these embodiments, the procedure 1300 may further include generating, by the UDM, a response that includes energy efficiency (EE) subscription information that includes a portion of the energy saving information. In some of these embodiments, the EE subscription information may include an indication that the UE has subscribed to energy saving service, an indication of an energy saving service for the UE, an energy saving threshold for the UE, or a subscribed energy credit limit for the UE. Further, the procedure 1300 may include identifying a request from a session management function (SMF) in some of these embodiments, wherein the response is generated based at least in part on identifying the request, the response to be provided to the SMF. In some of these embodiments, the procedure may include identifying a request from an access and mobility management function (AMF), wherein the response is generated based at least in part on identifying the request, the response to be provided to the AMF.

The procedure 1300 may include identifying an energy saving policy to implement for the UE based at least in part on the energy saving information in 1304. In some embodiments, the energy saving policy may include a quality of service (QoS) identified based at least in part on the energy saving information, a modified QoS when energy usage of the UE exceeds an energy credit limit, an energy saving policy activated time window, or energy policy validity information indicating when and where to activate the energy saving policy.

In some embodiments, the procedure 1300 may further include identifying an energy saving indication received in a request for service from the UE. The energy saving information may be identified based at least in part on the energy saving indication.

In some embodiments, the procedure 1300 may further include retrieving, by a policy control function (PCF), energy consumption information for the UE from an energy information function (EIF). The energy saving policy may be identified based at least in part on the energy consumption information.

In some embodiments, the procedure 1300 may further include identifying one or more specific services to which the energy saving policy is to be applied for the UE. The one or more specific services may include single network slice selection assistance information (S-NSSAI) or a non-public network (NPN) identifier (ID). The procedure 1300 may further include generating, by an access and mobility management function (AMF), an N2 message that indicates the one or more specific services.

Any one or more of the operations in FIG. 13 may be performed in a different order than shown and/or one or more of the operations may be performed concurrently in embodiments. Further, it should be understood that one or more of the operations may be omitted from and/or one or more additional operations may be added to the procedure 1300 in other embodiments.

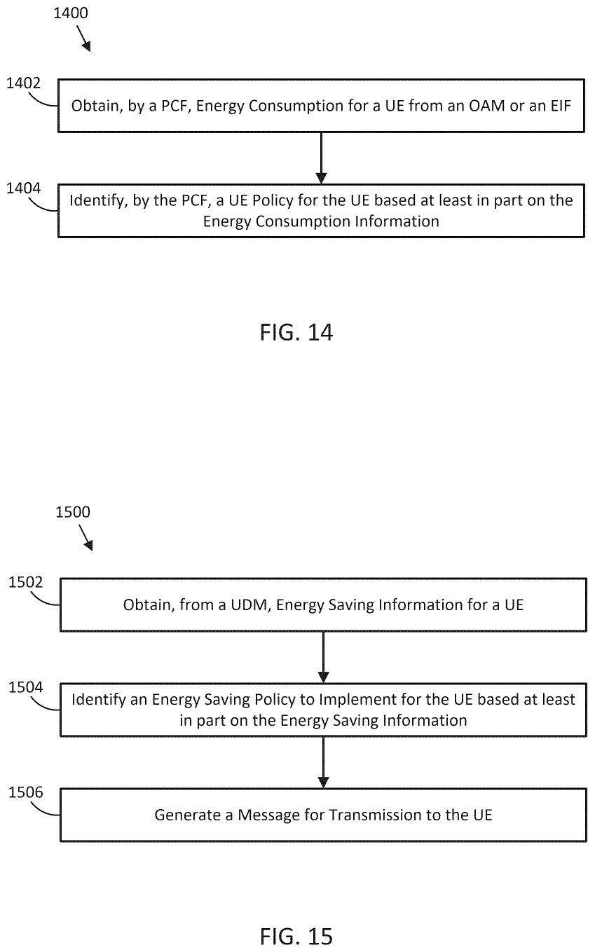

FIG. 14 illustrates an example procedure 1400 for identifying a UE policy for a UE in accordance with some embodiments. The procedure 1400 may be performed by a base station, such as the base station 108 (FIG. 1) and/or the network device 300 (FIG. 3).

The procedure 1400 may include obtaining, by a policy control function (PCF), energy consumption information for a user equipment (UE) from an operation, management, and administration (OAM) or an energy information function (EIF) in 1402. In some embodiments, the energy consumption information may include network function (NF) level energy consumption information, network slice level energy consumption information, network node level energy consumption information, protocol data unit (PDU) session level energy consumption information, UE level energy consumption information, or application level energy consumption information.

In some embodiments, obtaining the energy consumption information may include obtaining, from the OAM, network function (NF) level energy consumption information, network slice level energy consumption information, or network node level energy consumption information, and obtaining, from the EIF, protocol data unit (PDU) session level energy consumption information, UE level energy consumption information, or application level energy consumption information.

The procedure 1400 may include identifying, by the PCF, a UE policy for the UE based at least in part on the energy consumption information in 1404. In some embodiments, the UE policy may include a data network name (DNN) or network slice selection assistance information (NSSAI) with low energy consumption.

In some embodiments, the procedure 1400 may further include generating, by an access and mobility management function (AMF), a message that indicates the UE policy. The message may be for transmission to the UE to implement the UE policy.

In some embodiments, the procedure 1400 may further include identifying, an indication of results of delivery of the UE policy, the indication received from the UE.

In some embodiments, the procedure 1400 may further include identifying, by an access and mobility management function (AMF), a network slice selection assistance information (NSSAI) for the UE based at least in part on the energy consumption information. Further, the procedure 1400 may include generating an update command for transmission to the UE, the update command indicating the identified NSSAI.

Any one or more of the operations in FIG. 14 may be performed in a different order than shown and/or one or more of the operations may be performed concurrently in embodiments. Further, it should be understood that one or more of the operations may be omitted from and/or one or more additional operations may be added to the procedure 1400 in other embodiments.

FIG. 15 illustrates an example procedure 1500 for identifying an energy saving policy to implement for a UE in accordance with some embodiments. The procedure 1500 may be performed by a base station, such as the base station 108 (FIG. 1) and/or the network device 300 (FIG. 3).

The procedure 1500 may include obtaining, from a unified data management (UDM), energy saving information for a user equipment (UE) in 1502. The energy saving information may be identified based at least in part on an energy saving indication received from the UE.

In some embodiments, the UDM may identify the energy saving information. Further, the procedure 1500 may include generating, by the UDM, a response that includes energy efficiency (EE) subscription information that includes a portion of the energy saving information in these embodiments. In some of these embodiments, the EE subscription information may include an indication that the UE has subscribed to energy saving service, an indication of an energy saving service for the UE, an energy saving threshold for the UE, or a subscribed energy credit limit for the UE.

The procedure 1500 may include identifying an energy saving policy to implement for the UE based at least in part on the energy saving information in 1504.

In some embodiments, the procedure 1500 may include retrieving, by a policy control function (PCF), energy consumption information for the UE from an energy information function (EIF). The energy saving policy may be identified based at least in part on the energy consumption information.

The procedure 1500 may include generating a message for transmission to the UE in 1506. The message may include an indication of the energy saving policy.

Any one or more of the operations in FIG. 15 may be performed in a different order than shown and/or one or more of the operations may be performed concurrently in embodiments. Further, it should be understood that one or more of the operations may be omitted from and/or one or more additional operations may be added to the procedure 1500 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising identifying an energy saving trigger, and generating a request for service from a radio access network (RAN), the request including an energy saving indication based at least in part on identification of the energy saving trigger.

Example 2 may include the method of example 1, wherein the request comprises a protocol data unit (PDU) session establishment request.

Example 3 may include the method of example 1, wherein the request comprises a registration request.

Example 4 may include the method of example 1, further comprising identifying an indication of a user equipment (UE) policy, the UE policy identified based at least in part on energy consumption information obtained from an operation, management, administration (OAM) or an energy information function (EIF), updating a current UE policy with the UE policy, and generating an indication of results of updating the current UE policy.

Example 5 may include a method comprising obtaining, from a unified data management (UDM), energy saving information for a user equipment (UE), and identifying an energy saving policy to implement for the UE based at least in part on the energy saving information.

Example 6 may include the method of example 5, further comprising identifying an energy saving indication received in a request for service from the UE, wherein the energy saving information is identified based at least in part on the energy saving indication.

Example 7 may include the method of example 5, wherein the UDM identifies the energy saving information, and wherein the method further comprises generating, by the UDM, a response that includes energy efficiency (EE) subscription information that includes a portion of the energy saving information.

Example 8 may include the method of example 7, wherein the EE subscription information includes an indication that the UE has subscribed to energy saving service, an indication of an energy saving service for the UE, an energy saving threshold for the UE, or a subscribed energy credit limit for the UE.

Example 9 may include the method of example 7, further comprising identifying a request from a session management function (SMF), wherein the response is generated based at least in part on identifying the request, the response to be provided to the SMF.

Example 10 may include the method of example 7, further comprising identifying a request from an access and mobility management function (AMF), wherein the response is generated based at least in part on identifying the request, the response to be provided to the AMF.

Example 11 may include the method of example 5, further comprising retrieving, by a policy control function (PCF), energy consumption information for the UE from an energy information function (EIF), wherein the energy saving policy is identified based at least in part on the energy consumption information.

Example 12 may include the method of example 5, wherein the energy saving policy includes a quality of service (QoS) identified based at least in part on the energy saving information, a modified QoS when energy usage of the UE exceeds an energy credit limit, an energy saving policy activated time window, or energy policy validity information indicating when and where to activate the energy saving policy.

Example 13 may include the method of example 5, further comprising identifying one or more specific services to which the energy saving policy is to be applied for the UE, the one or more specific services including single network slice selection assistance information (S-NSSAI) or a non-public network (NPN) identifier (ID), and generating, by an access and mobility management function (AMF), an N2 message that indicates the one or more specific services.

Example 14 may include a method comprising obtaining, by a policy control function (PCF), energy consumption information for a user equipment (UE) from an operation, management, and administration (OAM) or an energy information function (EIF), and identifying, by the PCF, a UE policy for the UE based at least in part on the energy consumption information.

Example 15 may include the method of example 14, wherein the energy consumption information includes network function (NF) level energy consumption information, network slice level energy consumption information, network node level energy consumption information, protocol data unit (PDU) session level energy consumption information, UE level energy consumption information, or application level energy consumption information.

Example 16 may include the method of example 14, wherein obtaining the energy consumption information includes obtaining, from the OAM, network function (NF) level energy consumption information, network slice level energy consumption information, or network node level energy consumption information, and obtaining, from the EIF, protocol data unit (PDU) session level energy consumption information, UE level energy consumption information, or application level energy consumption information.

Example 17 may include the method of example 14, wherein the UE policy includes a data network name (DNN) or network slice selection assistance information (NSSAI) with low energy consumption.

Example 18 may include the method of example 14, further comprising generating, by an access and mobility management function (AMF), a message that indicates the UE policy, the message for transmission to the UE to implement the UE policy.

Example 19 may include the method of example 14, further comprising identifying an indication of results of delivery of the UE policy, the indication received from the UE.

Example 20 may include the method of example 14, further comprising identifying, by an access and mobility management function (AMF), a network slice selection assistance information (NSSAI) for the UE based at least in part on the energy consumption information, and generating an update command for transmission to the UE, the update command indicating the identified NSSAI.

Example 21 may include one or more non-transitory, computer-readable media having instructions that, when executed, cause processing circuitry to obtain, from a unified data management (UDM), energy saving information for a user equipment (UE), the energy saving information identified based at least in part on an energy saving indication received from the UE, identify an energy saving policy to implement for the UE based at least in part on the energy saving information, and generate a message for transmission to the UE, the message including an indication of the energy saving policy.

Example 22 may include the one or more non-transitory, computer-readable media of example 21, wherein the UDM identifies the energy saving information, and wherein the instructions, when executed, further cause the processing circuitry to generate, by the UDM, a response that includes energy efficiency (EE) subscription information that includes a portion of the energy saving information.

Example 23 may include the one or more non-transitory, computer-readable media of example 22, wherein the EE subscription information includes an indication that the UE has subscribed to energy saving service, an indication of an energy saving service for the UE, an energy saving threshold for the UE, or a subscribed energy credit limit for the UE.

Example 24 may include the one or more non-transitory, computer-readable media of example 21, wherein the instructions, when executed, further cause the processing circuitry to retrieve, by a policy control function (PCF), energy consumption information for the UE from an energy information function (EIF), wherein the energy saving policy is identified based at least in part on the energy consumption information.

Example 25 may include an apparatus comprising means to perform one or more elements of a method described in or related to any of examples 1-24, or any other method or process described herein.

Example 26 may include one or more non-transitory computer-readable media comprising instructions to cause an electronic device, upon execution of the instructions by one or more processors of the electronic device, to perform one or more elements of a method described in or related to any of examples 1-24, or any other method or process described herein.

Example 27 may include an apparatus comprising logic, modules, or circuitry to perform one or more elements of a method described in or related to any of examples 1-24, or any other method or process described herein.

Example 28 may include a method, technique, or process as described in or related to any of examples 1-24, or portions or parts thereof.

Example 29 may include an apparatus comprising: one or more processors and one or more computer-readable media comprising instructions that, when executed by the one or more processors, cause the one or more processors to perform the method, techniques, or process as described in or related to any of examples 1-24, or portions thereof.

Example 30 may include a signal as described in or related to any of examples 1-24, or portions or parts thereof.

Example 31 may include a datagram, information element, packet, frame, segment, PDU, or message as described in or related to any of examples 1-24, or portions or parts thereof, or otherwise described in the present disclosure.

Example 32 may include a signal encoded with data as described in or related to any of examples 1-24, or portions or parts thereof, or otherwise described in the present disclosure.

Example 33 may include a signal encoded with a datagram, IE, packet, frame, segment, PDU, or message as described in or related to any of examples 1-24, or portions or parts thereof, or otherwise described in the present disclosure.

Example 34 may include an electromagnetic signal carrying computer-readable instructions, wherein execution of the computer-readable instructions by one or more processors is to cause the one or more processors to perform the method, techniques, or process as described in or related to any of examples 1-24, or portions thereof.

Example 35 may include a computer program comprising instructions, wherein execution of the program by a processing element is to cause the processing element to carry out the method, techniques, or process as described in or related to any of examples 1-24, or portions thereof.

Example 36 may include a signal in a wireless network as shown and described herein.

Example 37 may include a method of communicating in a wireless network as shown and described herein.

Example 38 may include a system for providing wireless communication as shown and described herein.

Example 39 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
processing circuitry to:
obtain, from a unified data management (UDM), energy saving information for a user equipment (UE), the energy saving information identified based at least in part on an energy saving indication received from the UE;
identify an energy saving policy to implement for the UE based at least in part on the energy saving information; and
generate a message for transmission to the UE, the message including an indication of the energy saving policy; and
interface circuitry coupled to the processing circuitry, the interface circuitry to transmit the message.

2. The apparatus of claim 1, wherein the UDM identifies the energy saving information, and wherein the processing circuitry is further to:
generate, by the UDM, a response that includes energy efficiency (EE) subscription information that includes a portion of the energy saving information.

3. The apparatus of claim 2, wherein the EE subscription information includes:
an indication that the UE has subscribed to energy saving service;
an indication of an energy saving service for the UE;
an energy saving threshold for the UE; or
a subscribed energy credit limit for the UE.

4. The apparatus of claim 1, wherein the processing circuitry is further to:
retrieve, by a policy control function (PCF), energy consumption information for the UE from an energy information function (EIF), wherein the energy saving policy is identified based at least in part on the energy consumption information.

5. A method comprising:
obtaining, from a unified data management (UDM), energy saving information for a user equipment (UE); and
identifying an energy saving policy to implement for the UE based at least in part on the energy saving information.

6. The method of claim 5, further comprising:
identifying an energy saving indication received in a request for service from the UE, wherein the energy saving information is identified based at least in part on the energy saving indication.

7. The method of claim 5, wherein the UDM identifies the energy saving information, and wherein the method further comprises:
generating, by the UDM, a response that includes energy efficiency (EE) subscription information that includes a portion of the energy saving information.

8. The method of claim 7, wherein the EE subscription information includes:
an indication that the UE has subscribed to energy saving service;
an indication of an energy saving service for the UE;
an energy saving threshold for the UE; or
a subscribed energy credit limit for the UE.

9. The method of claim 7, further comprising:
identifying a request from a session management function (SMF), wherein the response is generated based at least in part on identifying the request, the response to be provided to the SMF.

10. The method of claim 7, further comprising:
identifying a request from an access and mobility management function (AMF), wherein the response is generated based at least in part on identifying the request, the response to be provided to the AMF.

11. The method of claim 5, further comprising:
retrieving, by a policy control function (PCF), energy consumption information for the UE from an energy information function (EIF), wherein the energy saving policy is identified based at least in part on the energy consumption information.

12. The method of claim 5, wherein the energy saving policy includes:
a quality of service (QoS) identified based at least in part on the energy saving information;
a modified QoS when energy usage of the UE exceeds an energy credit limit;
an energy saving policy activated time window; or
energy policy validity information indicating when and where to activate the energy saving policy.

13. The method of claim 5, further comprising:
identifying one or more specific services to which the energy saving policy is to be applied for the UE, the one or more specific services including single network slice selection assistance information (S-NSSAI) or a non-public network (NPN) identifier (ID); and
generating, by an access and mobility management function (AMF), an N2 message that indicates the one or more specific services.

14. A method comprising:
obtaining, by a policy control function (PCF), energy consumption information for a user equipment (UE) from an operation, management, and administration (OAM) or an energy information function (EIF); and
identifying, by the PCF, a UE policy for the UE based at least in part on the energy consumption information.

15. The method of claim 14, wherein the energy consumption information includes:
network function (NF) level energy consumption information;
network slice level energy consumption information;
network node level energy consumption information;
protocol data unit (PDU) session level energy consumption information;
UE level energy consumption information; or
application level energy consumption information.

16. The method of claim 14, wherein obtaining the energy consumption information includes:
obtaining, from the OAM, network function (NF) level energy consumption information, network slice level energy consumption information, or network node level energy consumption information; and
obtaining, from the EIF, protocol data unit (PDU) session level energy consumption information, UE level energy consumption information, or application level energy consumption information.

17. The method of claim 14, wherein the UE policy includes a data network name (DNN) or network slice selection assistance information (NSSAI) with low energy consumption.

18. The method of claim 14, further comprising:
generating, by an access and mobility management function (AMF), a message that indicates the UE policy, the message for transmission to the UE to implement the UE policy.

19. The method of claim 14, further comprising:
identifying an indication of results of delivery of the UE policy, the indication received from the UE.

20. The method of claim 14, further comprising:
identifying, by an access and mobility management function (AMF), a network slice selection assistance information (NSSAI) for the UE based at least in part on the energy consumption information; and
generating an update command for transmission to the UE, the update command indicating the identified NSSAI.
